(19) United States
(12) Patent Application Publication
(10) Pub. No.: US 2023/0081875 A1
(43) Pub. Date: Mar. 16, 2023

(54) METHOD AND SYSTEM FOR ANONYMOUS CASHLESS PAYMENTS

(71) Applicant: JPMorgan Chase Bank, N.A., New York, NY (US)

(72) Inventor: Howard SPECTOR, Woolwich, NJ (US)

(73) Assignee: JPMorgan Chase Bank, N.A., New York, NY (US)

(21) Appl. No.: 17/946,510

(22) Filed: Sep. 16, 2022

Related U.S. Application Data
(60) Provisional application No. 63/261,275, filed on Sep. 16, 2021.

(51) Int. Cl. G06Q 20/10; G06Q 20/40; G06Q 20/42; G06Q 20/32

(52) U.S. Cl. CPC G06Q 20/1085; G06Q 20/42; G06Q 20/3221; G06Q 20/3267; G06Q 20/3276; G06Q 20/4014; G06Q 20/4016

(57) ABSTRACT

Method and systems for facilitating cashless payments by using a smart phone without a requirement for any of a mobile application, an exchange of personally identifying information, or a payee account are provided. The method includes: receiving an identification number that corresponds to a request for payment submitted by a potential payee; retrieving, based on the identification number, identifying information that corresponds to an account associated with a potential payor; transmitting, to the potential payor, a first message that includes a request for a payment amount; receiving, from the potential payor, a second message that includes a confirmation and the payment amount; validating the request for payment; transferring, to the potential payee, a cookie that is associated with the requested payment amount; and when a confirmation that the requested payment has been completed is received, transmitting, to the payor, a confirmation that the payment has been completed.

### CROSS-REFERENCE TO RELATED APPLICATIONS

This application claims priority benefit from U.S. Provisional Application No. 63/261,275, filed Sep. 16, 2021, which is hereby incorporated by reference in its entirety.

### BACKGROUND

### 1. Field of the Disclosure

This technology generally relates to methods and systems for facilitating executions of transactions, and more particularly to methods and systems for facilitating cashless payments by using a smart phone without a requirement for any of a mobile application, an exchange of personally identifying information, or a payee account.

### 2. Background Information

In recent times, the use of cash and/or personal checks for effecting commercial transactions and personal exchanges of currency has been steadily decreasing, in favor of various alternative forms of payment that may be executed online and/or electronically, including the use of payment cards, such as charge cards, credit cards, and/or debit cards, and also including the use of mobile applications and services that may be downloadable to a computer or smart phone, such as PayPal, Venmo, and Zelle. In this regard, the use of online and electronic forms of payment provides a relatively fast and convenient way to transfer funds between persons and/or commercial entities.

One drawback to the use of conventional online and electronic forms of exchanging money is that an accompanying exchange of personally identifying and/or sensitive personal information may also be required. For example, the payor may be required to provide an account number and/or a card number which, if obtained by a malicious actor, could be used to fraudulently obtain access to the payor’s funds. Similarly, the payee may be required to provide an account number and/or other personally identifying information, such as a smart phone number or an email address, and the payee may prefer to keep such information confidential. In this aspect, the use of cash generally avoids the need to exchange personal and/or sensitive information, but does not avoid the inconveniences of carrying cash and effecting a physical, tangible exchange thereof.

Accordingly, there is a need for a method for facilitating anonymous cashless payments by using a smart phone without a requirement for any of a mobile application, an exchange of personally identifying information, or a payee account.

### SUMMARY

The present disclosure, through one or more of its various aspects, embodiments, and/or specific features or sub-components, provides, inter alia, various systems, servers, devices, methods, media, programs, and platforms for methods and systems for facilitating cashless payments by using a smart phone without a requirement for any of a mobile application, an exchange of personally identifying information, or a payee account.

According to an aspect of the present disclosure, a method for facilitating a cashless payment is provided. The method is implemented by at least one processor. The method includes: receiving, by the at least one processor, an identification number that corresponds to a request for payment submitted by a potential payee; retrieving, by the at least one processor based on the received identification number, identifying information that corresponds to an identity of a potential payor and an account associated with the potential payor; transmitting, by the at least one processor to the potential payor, a first message that includes a request for confirmation that the potential payor intends to make a payment to the potential payee and a request for an amount of the payment; receiving, by the at least one processor from the potential payor, a second message that includes the requested confirmation and the requested amount of the payment; validating, by the at least one processor based on the received second message, the request for payment; transferring, to the potential payee, a cookie that is associated with the requested amount of the payment; and when a confirmation that the requested payment has been completed is received, transmitting, by the at least one processor to the payor, a confirmation that the requested payment has been completed.

The method may further include determining, by the at least one processor, that a device associated with the potential payor is within a predetermined distance of a device associated with the potential payee.

The validating may include determining whether the account associated with the potential payor has sufficient funds for executing the requested payment.

The validating may further include determining whether the request for payment violates a rule relating to fraud prevention.

The validating may further include determining whether the request for payment is anomalous with respect to a pattern that has previously been observed with respect to the potential payor.

The identification number that corresponds to the request for payment may be received from an entity associated with a Uniform Resource Locator (URL) address accessed by the potential payee in order to submit the request for payment.

The method may further include: when a request for validation of an amount to be dispersed to the potential payee is received from a merchant, transmitting, to the merchant, a validation of the amount; deducting, from the account associated with the payor, the amount; marking the account with an indication that the requested payment has been completed; and coordinating with the merchant to ensure that the merchant receives compensation for the amount paid to the payee.

The method may further include transmitting, to the payee in conjunction with the transferring of the cookie, information that relates to at least one option for obtaining the requested payment which is displayable on a smart phone.

The information that relates to the at least one option for obtaining the requested payment may include at least one from among a tap at a first automatic teller machine (ATM) associated with a bank that administers the account associated with the potential payor; entering a code into the first ATM; scanning one from among a Quick Response (QR) code and a barcode at one from among a branch of the bank and a merchant location; information that is usable for obtaining the requested payment via an account that is hosted in a metaverse; and information that is usable by a money transfer application in order to have the payment delivered directly to a bank account associated with the potential payee.

According to another exemplary embodiment, a computing apparatus for facilitating a cashless payment is provided. The computing apparatus includes a processor; a memory; and a communication interface coupled to each of the processor and the memory. The processor is configured to: receive, via the communication interface, an identification number that corresponds to a request for payment submitted by a potential payee; retrieve, based on the received identification number, identifying information that corresponds to an identity of a potential payor and an account associated with the potential payor; transmit, via the communication interface to the potential payor, a first message that includes a request for confirmation that the potential payor intends to make a payment to the potential payee and a request for an amount of the payment; receive, via the communication interface from the potential payor, a second message that includes the requested confirmation and the requested amount of the payment; validate, based on the received second message, the request for payment; transfer, to the potential payee, a cookie that is associated with the requested amount of the payment; and when a confirmation that the requested payment has been completed is received, transmit, via the communication interface to the payor, a confirmation that the requested payment has been completed.

The processor may be further configured to determine that a device associated with the potential payor is within a predetermined distance of a device associated with the potential payee.

The processor may be further configured to perform the validation by determining whether the account associated with the potential payor has sufficient funds for executing the requested payment.

The processor may be further configured to perform the validation by determining whether the request for payment violates a rule relating to fraud prevention.

The processor may be further configured to perform the validation by determining whether the request for payment is anomalous with respect to a pattern that has previously been observed with respect to the potential payor.

The identification number that corresponds to the request for payment may be received from an entity associated with a Uniform Resource Locator (URL) address accessed by the potential payee in order to submit the request for payment.

The processor may be further configured to: when a request for validation of an amount to be dispersed to the potential payee is received from a merchant, transmit, via the communication interface to the merchant, a validation of the amount; deduct, from the account associated with the payor, the amount; mark the account with an indication that the requested payment has been completed; and coordinate with the merchant to ensure that the merchant receives compensation for the amount paid to the payee.

The processor may be further configured to transmit, via the communication interface to the payee in conjunction with the transferring of the cookie, information that relates to at least one option for obtaining the requested payment which is displayable on a smart phone.

The information that relates to the at least one option for obtaining the requested payment may include at least one from among a tap at a first automatic teller machine (ATM) associated with a bank that administers the account associated with the potential payor; entering a code into the first ATM; scanning one from among a Quick Response (QR) code and a barcode at one from among a branch of the bank and a merchant location; information that is usable for obtaining the requested payment via an account that is hosted in a metaverse; and information that is usable by a money transfer application in order to have the payment delivered directly to a bank account associated with the potential payee.

According to yet another exemplary embodiment, a non-transitory computer readable storage medium storing instructions for facilitating a cashless payment is provided. The storage medium includes executable code which, when executed by a processor, causes the processor to: receive an identification number that corresponds to a request for payment submitted by a potential payee; retrieve, based on the received identification number, identifying information that corresponds to an identity of a potential payor and an account associated with the potential payor; transmit, to the potential payor, a first message that includes a request for confirmation that the potential payor intends to make a payment to the potential payee and a request for an amount of the payment; receive, from the potential payor, a second message that includes the requested confirmation and the requested amount of the payment; validate, by the at least one processor based on the received second message, the request for payment; transfer, to the potential payee, a cookie that is associated with the requested amount of the payment; and when a confirmation that the requested payment has been completed is received, transmit, to the payor, a confirmation that the requested payment has been completed.

When executed by the processor, the executable code may further cause the processor to determine that a device associated with the potential payor is within a predetermined distance of a device associated with the potential payee.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for facilitating cashless payments by using a smart phone without a requirement for any of a mobile application, an exchange of personally identifying information, or a payee account.

FIG. 4 is a flowchart of an exemplary process for implementing a method for facilitating cashless payments by using a smart phone without a requirement for any of a mobile application, an exchange of personally identifying information, or a payee account.

FIG. 5 is a data flow diagram that illustrates a method for facilitating cashless payments by using a smart phone without a requirement for any of a mobile application, an exchange of personally identifying information, or a payee account, according to an exemplary embodiment.

FIG. 6 is a data flow diagram that illustrates an enrollment process for initiating a method for facilitating cashless payments by using a smart phone without a requirement for any of a mobile application, an exchange of personally identifying information, or a payee account, according to an exemplary embodiment.

FIG. 7 is a data flow diagram that illustrates a money transfer process in the context of a method for facilitating cashless payments by using a smart phone without a requirement for any of a mobile application, an exchange of personally identifying information, or a payee account, according to an exemplary embodiment.

FIG. 8 is a data flow diagram that illustrates a money receiving process in the context of a method for facilitating cashless payments by using a smart phone without a requirement for any of a mobile application, an exchange of personally identifying information, or a payee account, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

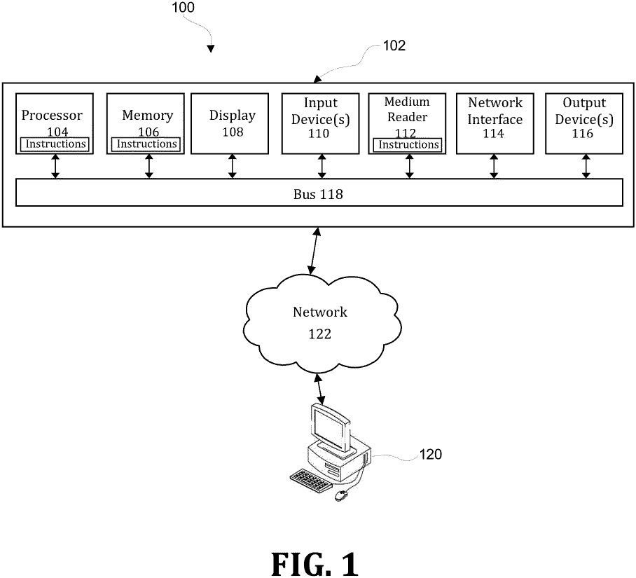

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or subsystems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for facilitating cashless payments by using a smart phone without a requirement for any of a mobile application, an exchange of personally identifying information, or a payee account.

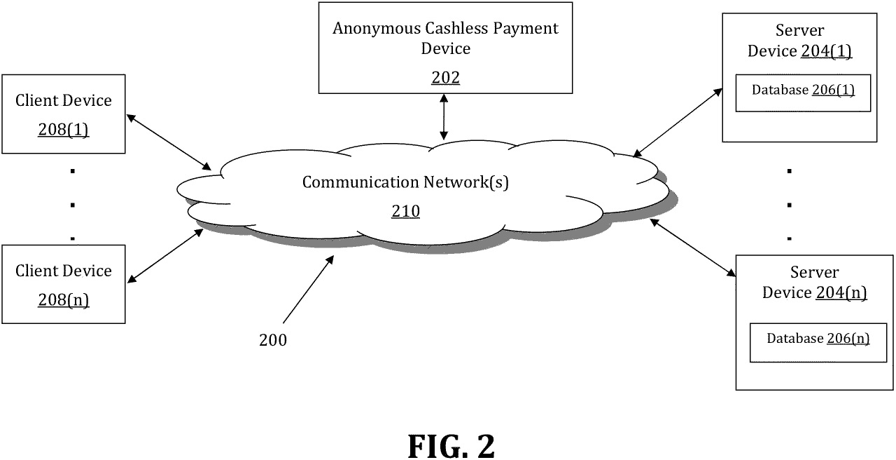

Referring to FIG. 2, a schematic of an exemplary network environment 200 for implementing a method for facilitating cashless payments by using a smart phone without a requirement for any of a mobile application, an exchange of personally identifying information, or a payee account is illustrated. In an exemplary embodiment, the method is executable on any networked computer platform, such as, for example, a personal computer (PC).

The method for facilitating cashless payments by using a smart phone without a requirement for any of a mobile application, an exchange of personally identifying information, or a payee account may be implemented by an Anonymous Cashless Payment (ACP) device 202. The ACP device 202 may be the same or similar to the computer system 102 as described with respect to FIG. 1. The ACP device 202 may store one or more applications that can include executable instructions that, when executed by the ACP device 202, cause the ACP device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ACP device 202 itself, may be located in virtual server(s) running in a cloud-based computing environment rather than being tied to one or more specific physical network computing devices. Also, the application(s) may be running in one or more virtual machines (VMs) executing on the ACP device 202. Additionally, in one or more embodiments of this technology, virtual machine(s) running on the ACP device 202 may be managed or supervised by a hypervisor.

In the network environment 200 of FIG. 2, the ACP device 202 is coupled to a plurality of server devices 204(1)-204(n) that hosts a plurality of databases 206(1)-206(n), and also to a plurality of client devices 208(1)-208(n) via communication network(s) 210. A communication interface of the ACP device 202, such as the network interface 114 of the computer system 102 of FIG. 1, operatively couples and communicates between the ACP device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ACP device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ACP devices that efficiently implement a method for facilitating cashless payments by using a smart phone without a requirement for any of a mobile application, an exchange of personally identifying information, or a payee account.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ACP device 202 may be a standalone device or integrated with one or more other devices or apparatuses, such as one or more of the server devices 204(1)-204(n), for example. In one particular example, the ACP device 202 may include or be hosted by one of the server devices 204(1)-204(n), and other arrangements are also possible. Moreover, one or more of the devices of the ACP device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ACP device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to individual payor accounts and information that relates to transaction settlements with commercial entities.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ACP device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ACP device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ACP device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ACP device 202, the server devices 204(1)-204(n), or the client devices 208(1)-208(n), for example, may be configured to operate as virtual instances on the same physical machine. In other words, one or more of the ACP device 202, the server devices 204(1)-204(n), or the client devices 208(1)-208(n) may operate on the same physical device rather than as separate devices communicating through communication network(s) 210. Additionally, there may be more or fewer ACP devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

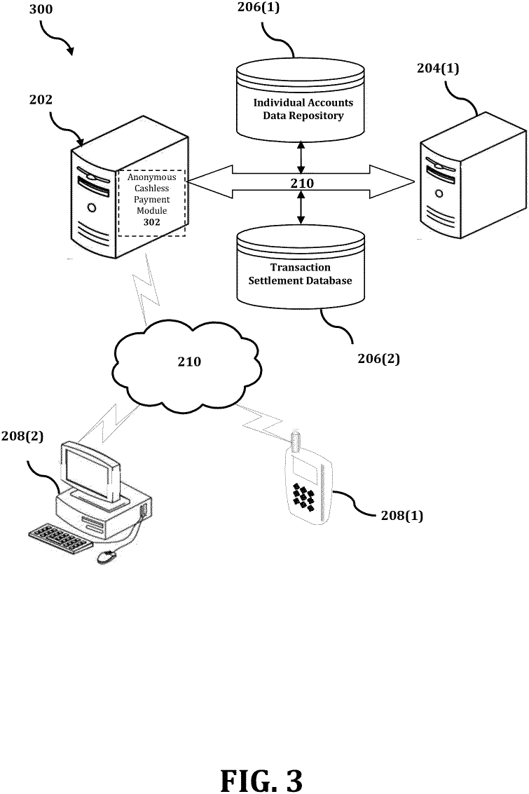

The ACP device 202 is described and illustrated in FIG. 3 as including an anonymous cashless payment module 302, although it may include other rules, policies, modules, databases, or applications, for example. As will be described below, the anonymous cashless payment module 302 is configured to implement a method for facilitating cashless payments by using a smart phone without a requirement for any of a mobile application, an exchange of personally identifying information, or a payee account.

An exemplary process 300 for implementing a mechanism for facilitating cashless payments by using a smart phone without a requirement for any of a mobile application, an exchange of personally identifying information, or a payee account by utilizing the network environment of FIG. 2 is illustrated as being executed in FIG. 3. Specifically, a first client device 208(1) and a second client device 208(2) are illustrated as being in communication with ACP device 202. In this regard, the first client device 208(1) and the second client device 208(2) may be “clients” of the ACP device 202 and are described herein as such. Nevertheless, it is to be known and understood that the first client device 208(1) and/or the second client device 208(2) need not necessarily be “clients” of the ACP device 202, or any entity described in association therewith herein. Any additional or alternative relationship may exist between either or both of the first client device 208(1) and the second client device 208(2) and the ACP device 202, or no relationship may exist.

Further, ACP device 202 is illustrated as being able to access an individual accounts data repository 206(1) and a transaction settlement information database 206(2). The anonymous cashless payment management module 302 may be configured to access these databases for implementing a method for facilitating cashless payments by using a smart phone without a requirement for any of a mobile application, an exchange of personally identifying information, or a payee account.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ACP device 202 via broadband or cellular communication. Of course, these embodiments are merely exemplary and are not limiting or exhaustive.

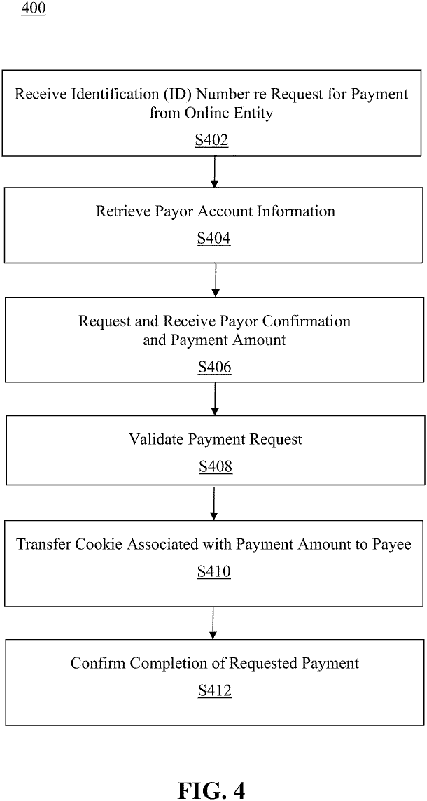

Upon being started, the anonymous cashless payment module 302 executes a process for facilitating cashless payments by using a smart phone without a requirement for any of a mobile application, an exchange of personally identifying information, or a payee account. An exemplary process for facilitating cashless payments by using a smart phone without a requirement for any of a mobile application, an exchange of personally identifying information, or a payee account is generally indicated at flowchart 400 in FIG. 4.

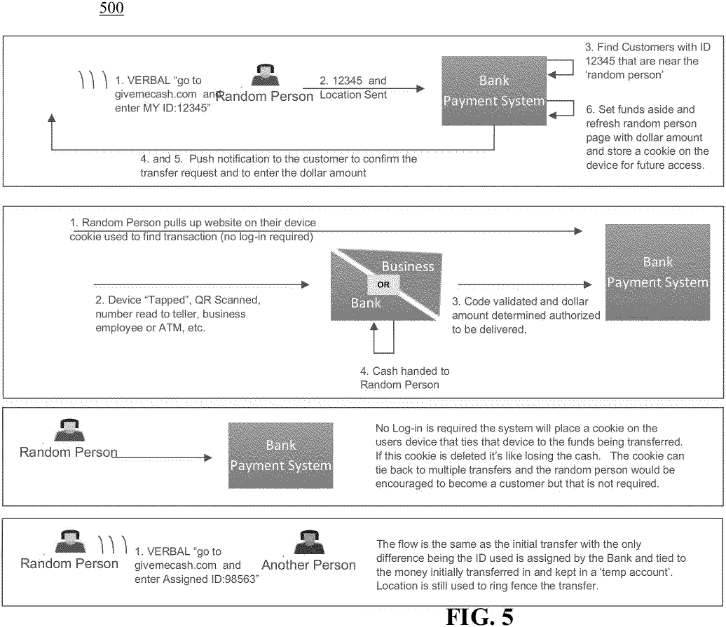

In process 400 of FIG. 4, at step S402, the anonymous cashless payment module 302 receives an identification (ID) number that indicates that a request for payment is thereby submitted. In an exemplary embodiment, this may occur when a potential payor desires to make a cashless transfer money to a potential payee anonymously and without the need to download a mobile application, and also without the need for the potential payee to have an account with any particular bank or financial institution - such as, for example, if the potential payor wishes to pay a tip to a person that has rendered an in-person service to the potential payor. In such a scenario, referring to also to FIG. 5, instead of paying cash or exchanging personal or sensitive information, as illustrated at item #1 at the left side of the top portion of data flow diagram 500 of FIG. 5, the potential payor may simply ask the potential payee to “go to givemecash.com [or any other suitable web site or Uniform Resource Locator address] and enter MY ID: 12345”. In this manner, the potential payee may submit the request for payment by entering an ID number given by the potential payor, which is routed through an online entity to a bank or financial institution at which the potential payor has an account. Further, in an exemplary embodiment, as illustrated at item #2 at the center of the top portion of FIG. 5, in addition to the ID number being sent to the bank, a location of the potential payee may also be sent to the bank.

At step S404, the anonymous cashless payment module 302 uses the received ID number to retrieve account information relating to the potential payor, including an identity of the potential payor and an account number that is associated with the potential payor. As illustrated at item #3 on the right side of the top portion of FIG. 5, the retrieval may be performed by finding customers that are associated with the received ID number and are located in close proximity to the potential payee. In an exemplary embodiment, the determination as to whether the customer is located in close proximity to the potential payee may be performed via communication with a smart phone that is associated with the customer, and this determination may require that the customer has enabled a location services feature on the smart phone.

At step S406, the anonymous cashless payment module 302 transmits a request for confirmation that the potential payor intends to make a payment to the potential payee and a request for an amount of the payment. Then, the anonymous cashless payment module 302 receives the requested confirmation and the requested amount of the payment. As illustrated at item #4 in the center of the top portion of FIG. 5, this step may be implemented by a transmission of a push notification to the smart phone of the customer to confirm the transfer request and to enter the appropriate dollar amount. In this aspect, the fact that the potential payee knows the ID number provided by the potential payor does not compromise the security of the potential payor’s account, because even if the potential payee later attempts to fraudulently obtain additional funds from the payor’s account, the attempt would be foiled by the fact that the payor would not confirm the subsequent payment request, and instead would be alerted to the attempted fraud. Alternatively, the payor may be required to obtain a new ID number prior to each transaction. This may be implemented by, for example, the payor sending a text message from a known device to a known short code or number associated with the anonymous cashless payment module 302; or by the payor using a mobile application or a website or virtual assistant that communicates with the anonymous cashless payment module 302. In this regard, the ID number may be fixed, or it may vary from transaction to transaction.

At step S408, the anonymous cashless payment module 302 validates the payment request. In an exemplary embodiment, based on the received confirmation and the received payment amount, the validation may be performed by determining whether the account associated with the potential payor has sufficient funds for executing the requested payment. In an exemplary embodiment, the validation may also include confirming that the potential payee and the potential payor are located within a relatively close proximity with respect to each other by determining that a device, such as a smart phone, associated with the potential payor is located within a predetermined distance of a device, such as a smart phone of the potential payee.

At step S410, the anonymous cashless payment module 302 transfers a cookie that is associated with the requested amount of the payment to the potential payee. The payee may then use the cookie to obtain the requested payment. In addition, the account balance of the potential payor is adjusted to reflect a reduction based on the requested payment amount. In an exemplary embodiment, the payee may obtain the requested payment by visiting a branch or an automatic teller machine (ATM) associated with the bank of the payor and then using the smart phone to present the cookie thereto. In an exemplary embodiment, the cookie is tied to a device that first uses the ID number provided to by the payor. If that same device is used to enter a second ID number, then that device will have two associated transactions. In an exemplary embodiment, the bank of the payor may have a branch that is hosted in a metaverse, and in this circumstance, the payee may obtain the requested payment by accessing the branch that is hosted in the metaverse and then using the smart phone to present the cookie thereto.

In an exemplary embodiment, for added convenience, the bank may have agreements with selected merchants, such as convenience stores and/or establishments that have multiple locations, to redeem such payments when a potential payee presents the cookie at a location associated with such a merchant. In this aspect, the cookie is similar to cash, in that it is deemed as being possessed by the bearer of the cookie, and therefore, if the cookie is inadvertently deleted, then the potential payee is no longer able to receive the requested payment, similarly as if the payee had received and then lost a $20 bill. In an exemplary embodiment, the cookie is used by the device to create a bar code and/or a Quick Response (QR) code that is readable by a merchant, for example, by using a scanner at a point-of-sale device, or an application programming interface (API) that is provided by the bank for integration with the merchant. In an exemplary embodiment, such a bar code and/or QR code may contain a single-use credit card, debit card, charge card, or payment card that can be used for conducting a transaction. In an exemplary embodiment, such merchant agreements may also include a predetermined maximum amount that is transferable, such as, for example, $100 or $300, in order to minimize an inconvenience of the merchant with respect to having a supply of available cash for executing such a transaction with a payee.

At step S412, the anonymous cashless payment module 302 confirms a completion of the requested payment and transmits a confirmation message to the payor that the requested payment has been completed.

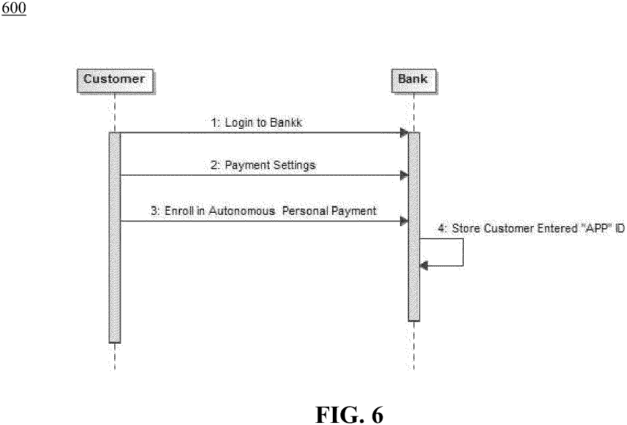

FIG. 6 is a data flow diagram 600 that illustrates an enrollment process for initiating a method for facilitating cashless payments by using a smart phone without a requirement for any of a mobile application, an exchange of personally identifying information, or a payee account, according to an exemplary embodiment. As illustrated in data flow diagram 600, the method for facilitating cashless payments according to an exemplary embodiment may be initiated by a set-up procedure that includes the following operations: 1) A customer of a bank logs in to an online application associated with the bank. 2) The customer accesses payment settings parameters that correspond to facilitating anonymous cashless payments. 3) The customer enrolls in an anonymous personal payment program that is administered by the bank. 4) The bank stores an application ID number that is entered by the customer in a database that stores account information for the customer.

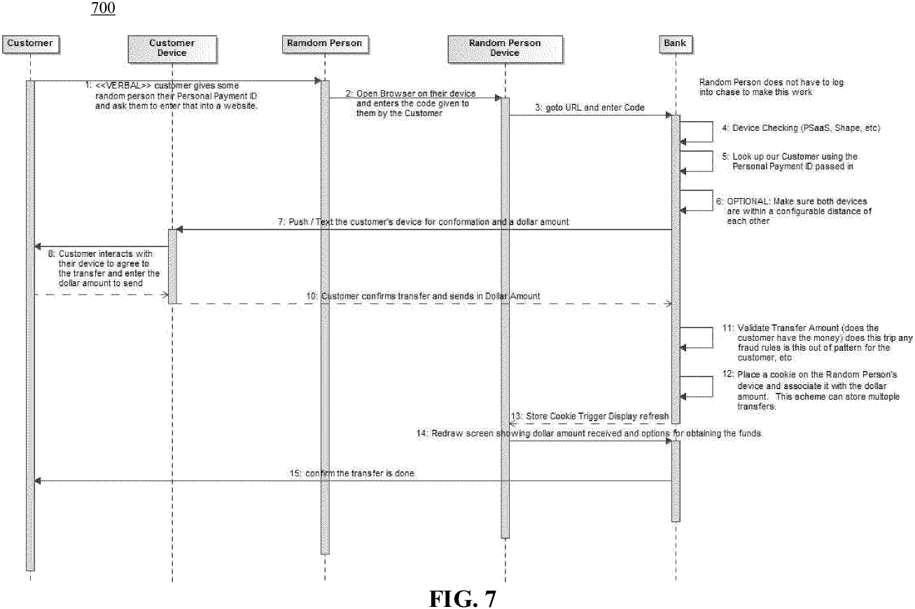

FIG. 7 is a data flow diagram 700 that illustrates a money transfer process in the context of a method for facilitating cashless payments by using a smart phone without a requirement for any of a mobile application, an exchange of personally identifying information, or a payee account, according to an exemplary embodiment. As illustrated in data flow diagram 700, the method for facilitating cashless payments according to an exemplary embodiment may be effectuated as between a customer, a smart phone of the customer (i.e., a “customer device”), a random person, a smart phone of the random person (i.e., a “random person device”), and a bank based on a procedure that includes the following operations:

1) The customer verbally provides a personal payment ID number to the random person, and asks the random person to enter that ID number into a website. 2) The random person opens a web browser on his/her smart phone and enters the code (i.e., the ID number) provided by the customer. 3) The smart phone of the random person accesses the URL of the website and then transmits the code to the bank.

4) The bank performs a device check. 5) The bank uses the received ID number to retrieve identifying information about the customer, including account information associated with the customer. 6) The bank checks whether the smart phone of the customer is located within a configurable distance of the smart phone of the random person.

7) The bank sends a text and/or a push notification to the smart phone of the customer to request confirmation of the payment request and a dollar amount. 8) and 9) The customer interacts with his/her smart phone to agree to the transfer and enter the dollar amount to be transferred. 10) The customer’s smart phone transmits a response to the bank that includes the requested confirmation and the amount.

11) The bank performs a validation of the request for payment, which includes checking the customer’s account to make sure that sufficient funds are available for the requested payment. The validation may also include a determination as to whether the request for payment violates any internal bank rules relating to fraud prevention and/or whether the request for payment appears to be unusual or outside of a pattern that has previously been observed with respect to the customer.

12) After the request for payment is validated, the bank places a cookie on the smart phone of the random person and associates the cookie with the appropriate dollar amount. The cookie may be associated with multiple payments / transfers. 13) The cookie is stored on the smart phone of the random person and a display refresh thereof is triggered, so that the random person can see its presence on the smart phone. 14) The smart phone of the random person displays a screen that shows the dollar amount to be received and options for obtaining the funds. 15) The bank sends a notification to the customer to confirm that the payment has been completed.

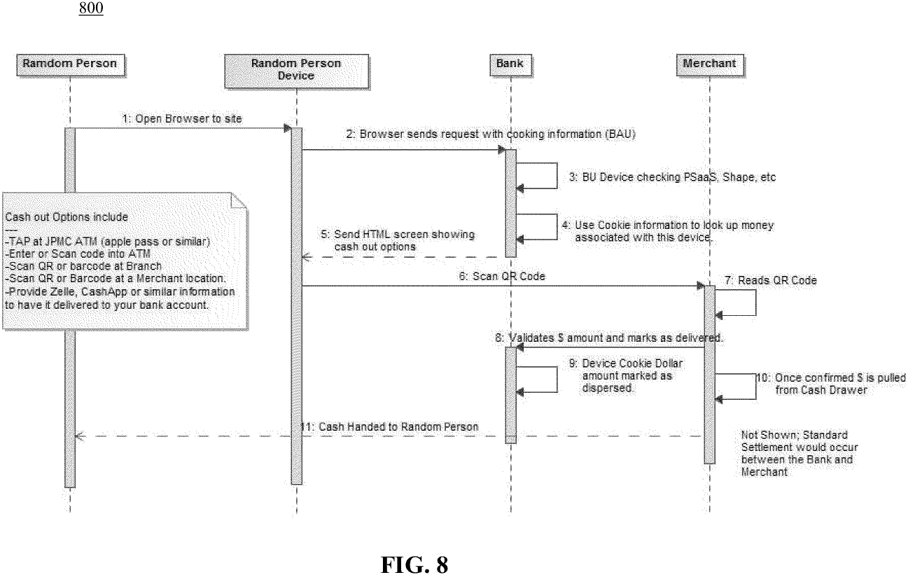

FIG. 8 is a data flow diagram 800 that illustrates a money receiving process in the context of a method for facilitating cashless payments by using a smart phone without a requirement for any of a mobile application, an exchange of personally identifying information, or a payee account, according to an exemplary embodiment. As illustrated in data flow diagram 800, the receiving of money by the payee as a result of executing a method for facilitating cashless payments according to an exemplary embodiment may be effectuated as between a random person, a smart phone of the random person (i.e., a “random person device”), a bank, and a participating merchant based on a procedure that includes the following operations:

1) The random person uses his/her smart phone to open a browser to the web site previously indicated by the payor. 2) The browser sends a request to the bank with the cookie that was received from the bank. 3) The bank performs a device check. 4) The bank uses the cookie information to retrieve money / funding information associated with the smart phone of the random person.

5) The bank sends information to the smart phone of the random person to be displayed thereon, including information regarding options for obtaining the funds. In an exemplary embodiment, the cash out options may include any one or more of a tap at an automatic teller machine (ATM) associated with the bank; entering or scanning a code into such an ATM; scanning a Quick Response (QR) code or a barcode at a branch of the bank; scanning a QR code or a barcode at a merchant location; and providing Zelle, CashApp, information that is usable for obtaining the requested payment via an account that is hosted in a metaverse, or similar information to have the payment delivered directly to a bank account associated with the payee, i.e., the random person.

6) The smart phone of the random person scans the QR code and transmits it to the merchant. 7) The merchant reads the QR code. 8) The merchant validates the requested dollar amount and marks the request as being delivered, and sends a corresponding message to the bank. 9) The bank marks the cookie to indicate that the dollar amount has been dispersed to the random person. 10) The merchant retrieves the requested dollar amount from a cash drawer. 11) The merchant hands the cash to the random person. In addition, the usual settlement process as between the bank and the merchant is performed to ensure that the merchant receives compensation for the payment that has been made to the random person.

Accordingly, with this technology, an optimized process for facilitating cashless payments by using a smart phone without a requirement for any of a mobile application, an exchange of personally identifying information, or a payee account is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subj ect matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for facilitating a cashless payment, the method being implemented by at least one processor, the method comprising:
receiving, by the at least one processor, an identification number that corresponds to a request for payment submitted by a potential payee;
retrieving, by the at least one processor based on the received identification number, identifying information that corresponds to an identity of a potential payor and an account associated with the potential payor;
transmitting, by the at least one processor to the potential payor, a first message that includes a request for confirmation that the potential payor intends to make a payment to the potential payee and a request for an amount of the payment;
receiving, by the at least one processor from the potential payor, a second message that includes the requested confirmation and the requested amount of the payment;
validating, by the at least one processor based on the received second message, the request for payment;
transferring, to the potential payee, a cookie that is associated with the requested amount of the payment; and
when a confirmation that the requested payment has been completed is received, transmitting, by the at least one processor to the payor, a confirmation that the requested payment has been completed.

2. The method of claim 1, further comprising determining, by the at least one processor, that a device associated with the potential payor is within a predetermined distance of a device associated with the potential payee.

3. The method of claim 1, wherein the validating comprises determining whether the account associated with the potential payor has sufficient funds for executing the requested payment.

4. The method of claim 3, wherein the validating further comprises determining whether the request for payment violates a rule relating to fraud prevention.

5. The method of claim 3, wherein the validating further comprises determining whether the request for payment is anomalous with respect to a pattern that has previously been observed with respect to the potential payor.

6. The method of claim 1, wherein the identification number that corresponds to the request for payment is received from an entity associated with a Uniform Resource Locator (URL) address accessed by the potential payee in order to submit the request for payment.

7. The method of claim 1, further comprising:
when a request for validation of an amount to be dispersed to the potential payee is received from a merchant, transmitting, to the merchant, a validation of the amount;
deducting, from the account associated with the payor, the amount;
marking the account with an indication that the requested payment has been completed; and
coordinating with the merchant to ensure that the merchant receives compensation for the amount paid to the payee.

8. The method of claim 1, further comprising transmitting, to the payee in conjunction with the transferring of the cookie, information that relates to at least one option for obtaining the requested payment which is displayable on a smart phone.

9. The method of claim 8, wherein the information that relates to the at least one option for obtaining the requested payment includes at least one from among a tap at a first automatic teller machine (ATM) associated with a bank that administers the account associated with the potential payor; entering a code into the first ATM; scanning one from among a Quick Response (QR) code and a barcode at one from among a branch of the bank and a merchant location; information that is usable for obtaining the requested payment via an account that is hosted in a metaverse; and information that is usable by a money transfer application in order to have the payment delivered directly to a bank account associated with the potential payee.

10. A computing apparatus for facilitating a cashless payment, the computing apparatus comprising:
a processor;
a memory; and
a communication interface coupled to each of the processor and the memory, wherein the processor is configured to:
receive, via the communication interface, an identification number that corresponds to a request for payment submitted by a potential payee;
retrieve, based on the received identification number, identifying information that corresponds to an identity of a potential payor and an account associated with the potential payor;
transmit, via the communication interface to the potential payor, a first message that includes a request for confirmation that the potential payor intends to make a payment to the potential payee and a request for an amount of the payment;
receive, via the communication interface from the potential payor, a second message that includes the requested confirmation and the requested amount of the payment;
validate, based on the received second message, the request for payment;
transfer, to the potential payee, a cookie that is associated with the requested amount of the payment; and
when a confirmation that the requested payment has been completed is received, transmit, via the communication interface to the payor, a confirmation that the requested payment has been completed.

11. The computing apparatus of claim 10, wherein the processor is further configured to determine that a device associated with the potential payor is within a predetermined distance of a device associated with the potential payee.

12. The computing apparatus of claim 10, wherein the processor is further configured to perform the validation by determining whether the account associated with the potential payor has sufficient funds for executing the requested payment.

13. The computing apparatus of claim 12, wherein the processor is further configured to perform the validation by determining whether the request for payment violates a rule relating to fraud prevention.

14. The computing apparatus of claim 12, wherein the processor is further configured to perform the validation by determining whether the request for payment is anomalous with respect to a pattern that has previously been observed with respect to the potential payor.

15. The computing apparatus of claim 10, wherein the identification number that corresponds to the request for payment is received from an entity associated with a Uniform Resource Locator (URL) address accessed by the potential payee in order to submit the request for payment.

16. The computing apparatus of claim 10, wherein the processor is further configured to:
when a request for validation of an amount to be dispersed to the potential payee is received from a merchant, transmit, via the communication interface to the merchant, a validation of the amount;
deduct, from the account associated with the payor, the amount;
mark the account with an indication that the requested payment has been completed; and
coordinate with the merchant to ensure that the merchant receives compensation for the amount paid to the payee.

17. The computing apparatus of claim 10, wherein the processor is further configured to transmit, via the communication interface to the payee in conjunction with the transferring of the cookie, information that relates to at least one option for obtaining the requested payment which is displayable on a smart phone.

18. The computing apparatus of claim 17, wherein the information that relates to the at least one option for obtaining the requested payment includes at least one from among a tap at a first automatic teller machine (ATM) associated with a bank that administers the account associated with the potential payor; entering a code into the first ATM; scanning one from among a Quick Response (QR) code and a barcode at one from among a branch of the bank and a merchant location; information that is usable for obtaining the requested payment via an account that is hosted in a metaverse; and information that is usable by a money transfer application in order to have the payment delivered directly to a bank account associated with the potential payee.

19. A non-transitory computer readable storage medium storing instructions for facilitating a cashless payment, the storage medium comprising executable code which, when executed by a processor, causes the processor to:
receive an identification number that corresponds to a request for payment submitted by a potential payee;
retrieve, based on the received identification number, identifying information that corresponds to an identity of a potential payor and an account associated with the potential payor;
transmit, to the potential payor, a first message that includes a request for confirmation that the potential payor intends to make a payment to the potential payee and a request for an amount of the payment;
receive, from the potential payor, a second message that includes the requested confirmation and the requested amount of the payment;
validate, by the at least one processor based on the received second message, the request for payment;
transfer, to the potential payee, a cookie that is associated with the requested amount of the payment; and
when a confirmation that the requested payment has been completed is received, transmit, to the payor, a confirmation that the requested payment has been completed.

20. The storage medium of claim 19, wherein when executed by the processor, the executable code further causes the processor to determine that a device associated with the potential payor is within a predetermined distance of a device associated with the potential payee.
